(19) United States
(12) Patent Application Publication
(10) Pub. No.: US 2026/0276521 A1
(43) Pub. Date: Sep. 17, 2026

(54) DEVICE FOR LOCATING AN INDIVIDUAL PARTICLE IN A SAMPLE AND ASSOCIATED METHOD

(71) Applicants: PARIS SCIENCES ET LETTRES, PARIS (FR); ECOLE SUPERIEURE DE PHYSIQUE ET DE CHIMIE INDUSTRIELLES DE LA VILLE DE PARIS, PARIS (FR); UNIVERSITE PARIS-SACLAY, GIF-SUR-YVETTE (FR); CENTRE NATIONAL DE LA RECHERCHE SCIENTIFIQUE, PARIS (FR)

(72) Inventors: Emmanuel FORT, PARIS (FR); Sandrine LEVÊQUE-FORT, ORSAY (FR); Maximilien LENGAUER, PARIS (FR)

(21) Appl. No.: 19/157,087

(22) PCT Filed: Feb. 16, 2024
(86) PCT No.: PCT/EP2024/053974

§ 371 Date: Aug. 15, 2025

(30) Foreign Application Priority Data
Feb. 17, 2023 (FR) FR2301501

(51) Int. Cl. G01N 15/1434; G01N 15/00; G01N 15/1429; G02B 21/00; G02B 27/58

(52) U.S. Cl. CPC G01N 15/1434; G01N 15/1429; G02B 21/0032; G02B 21/0056; G02B 21/0076; G02B 21/0084; G02B 27/58; G01N 2015/0038; G01N 2015/1454

(57) ABSTRACT

The invention relates to a device (100) for localizing an individualized particle (2) in a sample (3) having several regions (31), the particle being adapted to emit photons when it receives light, the device comprising:
a support (110) for the sample;
a light source arranged to produce an illumination field adapted to illuminate the sample placed on its support, an intensity of the illumination field having a temporal and spatial variation, so that said intensity has, in each region of the sample, a predetermined temporal pattern different from the temporal patterns of said intensity in the other regions;
a detector (140) adapted to convert the photons emitted by the particle in response to its illumination by the illumination field, into a signal representative of the intensity of the illumination field received by the particle;
a computer (150) programmed to determine, on the basis of a temporal evolution of the signal from the detector and the temporal and spatial variation of the intensity of the illumination field, the region of the sample in which the particle is localized.

### TECHNICAL FIELD OF THE INVENTION

The present invention concerns generally the field of microscopy.

It concerns more particularly a device for localizing an individualized particle in a sample.

It also concerns a method of localizing an individualized particle in a sample.

The invention finds a particularly advantageous application in the production of super-resolution microscopy devices.

### STATE OF THE ART

The 2014 Nobel Prize in Physics was awarded to revolutionary ideas of super-resolution fluorescence microscopy, which allow to go beyond the diffraction limit to obtain images with nanometric resolution and thus reveal cellular architecture at the molecular level. One of the central principles of this super-resolution microscopy is based on the temporal control of fluorescent molecular markers. These are activated sequentially in order to maintain emitter densities low enough to isolate them spatially and localize them individually with nanometric precision. In other words, this super-resolution microscopy makes it possible to localize individual particles in a sample with extreme precision. These localizations on successive images, on which the particles appear sparse, are then combined in order to reform a super-resolution image of the sample.

Current techniques, however, require cameras comprising arrays of sensors (also called pixels) to enable wide-field localization of molecules. These cameras are relatively slow detectors and faster ones are very expensive. Some applications, such as fluorescence lifetime measurements, are thus inaccessible due to the low sampling frequency of these cameras.

### PRESENTATION OF THE INVENTION

Therefore, one aim of the invention is to enable the localization of light-emitting particles quickly and reliably.

In this context, the present invention proposes a device for localizing an individual particle in a sample having several regions, the particle being adapted to emit photons when it receives light, the device comprising:
a sample holder;
a light source arranged to produce an illumination field suitable for illuminating the sample placed on its support, an intensity of the illumination field having temporal and spatial variation, such that said intensity has, in each region of the sample, a predetermined temporal pattern different from the temporal patterns of said intensity in the other regions;
a detector adapted to convert photons emitted by the particle in response to its illumination by the illumination field into a signal representative of the intensity from the illumination field received by the particle;
a computer program to determine, on the basis of a temporal evolution of the signal from the detector and of the temporal and spatial variation of the intensity of the illumination field, the region of the sample in which the particle is localized.

Thus, thanks to the invention, the localization of the particle is coded bijectively by means of the temporal patterns, that is to say by means of the illumination field which is structured spatially and which is variable in time. This coding thus allows a super-localization of the entire observation field with a single detector.

Indeed, the position information of the particle is contained in the amplitude variation of the signal which is generated by the detector. Thus, although the detector cannot by itself spatially determine the origin of the photons it receives, the temporal evolution of the signal it generates is representative of the temporal pattern that illuminates the particle. The analysis of this temporal evolution makes it possible to go back to the region of the particle.

Therefore, it is not necessary to image the sample in wide field with a camera to determine the position of the particle in the sample, which significantly increases the acquisition speed.

The invention thus allows advantageously to overcome the limitations imposed by the sampling frequencies of the cameras.

Furthermore, the applicant has demonstrated, by means of a calculation of the Cramèr-Rao bound, that with such a spatially structured and time-varying illumination field, a localization precision of 2.4 times better in one dimension and 1.7 times better in two dimensions than that obtained by traditional localization can be achieved.

In summary, remarkably, the localization of the particle by means of the device according to the invention is precise and rapid.

To illustrate the type of bijective coding proposed in the invention, it is for example provided, according to an advantageous and non-limiting characteristic of the invention, that each temporal pattern of the intensity of the illumination field produced by the light source is a periodic temporal variation of this intensity and has a specific frequency, the specific frequencies of the temporal patterns associated with all regions being distinct from each other.

So, each region is associated with a unique specific frequency. Therefore, there is no ambiguity about the location of the particle, even when using a single detector instead of a camera.

Other advantageous and non-limiting characteristics of the device according to the invention, taken individually or according to all technically possible combinations are the following ones:
each temporal pattern of the intensity of the illumination field produced by the light source is a periodic temporal variation of this intensity and has a specific frequency, the specific frequencies of the temporal patterns associated with all regions being distinct from each other;
the regions of the sample are aligned along a main direction of the support and said light source is arranged so that each specific frequency is linked by a same relationship to a distance between the position of the region associated with the corresponding temporal pattern and a reference position along the main direction;
the said relationship is a relationship of proportionality;
each temporal pattern of the intensity of the illumination field produced by the light source is a sinusoidal temporal variation of this intensity;
the illumination field is adapted to simultaneously illuminate several regions of the sample;
the light source comprises an optical device for separating beams and a converging element arranged to generate and make interfere two light beams with each other so as to produce interference fringes at the level of the sample placed on its support;
the optical device for separating beams comprises at least one of the following: a wedge mirror with two perpendicular reflecting surfaces, a mirror and a partially reflecting blade; a separating cube having a partially reflective internal diagonal surface;
the light source further comprises a movable optical element, the movement of which causes said interference fringes to scroll to produce each temporal pattern of the intensity of the illumination field;
said movable optical element comprises a rotating device arranged to vary over time an angle of incidence of each light beam on the sample placed on its support, the angles of incidence of the light beams varying simultaneously and in opposite directions;
the rotating device is a rotating mirror;
the light source comprises a polarization modulator adapted to modify the polarization of the illumination field so that the illumination field is polarized, sequentially or simultaneously, according to: a first polarization direction; and a second polarization direction distinct from the first polarization direction; the computer being programmed to determine a position of the particle according to the first main direction and according to the second main direction as a function of the polarization of the illumination field;
when the illumination field is simultaneously polarized according to the first and to the second direction, the specific frequencies of temporal patterns associated with the first polarization direction are distinct from the specific frequencies of temporal patterns associated with the second polarization direction.

The invention also provides a method of localizing an individualized particle in a sample having several regions, the particle being adapted to emit photons when it receives light, the method comprising the following steps:
arranging the sample on a support;
producing an illumination field, the illumination field illuminating the sample placed on the support, an intensity of the illumination field having a temporal and spatial variation, such that said intensity has, in each region of the sample, a predetermined temporal pattern different from the temporal patterns of said intensity in the other regions;
converting the photons emitted by the particle in response to its illumination by the illumination field into a signal representative of the intensity of the illumination field received by the particle;
determining, on the basis of a temporal evolution of the signal from the detector and the temporal and spatial variation of the intensity of the illumination field, the region of the sample in which the particle is localized.

Other advantageous and non-limiting characteristics of the method according to the invention, taken individually or in all technically possible combinations, are the following ones:
the particle is selected from the group including: the diffusing particles, the fluorescent particles, the phosphorescent particles, the quantum dots, fluorescent proteins, dye molecules;
the particle is fluorescent, the illumination field is produced by a pulsed laser at a frequency greater than 1 MHz and the detector is adapted to count single photons, the method comprising a step of determining a delay between a pulse of the laser and the emission of a photon by the particle.

### DETAILED DESCRIPTION OF THE INVENTION

The description which follows with reference to the appended drawings, given as non-limiting examples, will make it clear what the invention consists of and how it can be implemented.

On the attached drawings:

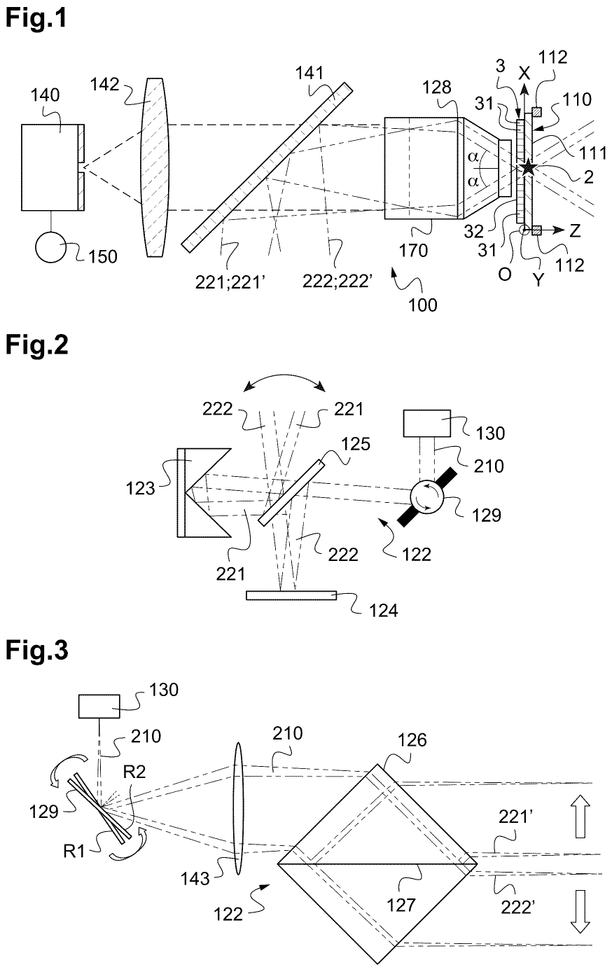

FIG. 1 is a schematic representation seen from above of a device for localizing an individualized particle in a sample according to a first embodiment,

FIG. 2 is a schematic representation seen from above of a first example of an optical separation device and of a movable optical element of the device of FIG. 1,

FIG. 3 is a schematic representation seen from above of a second example of an optical separation device and a movable optical element of the device of FIG. 1,

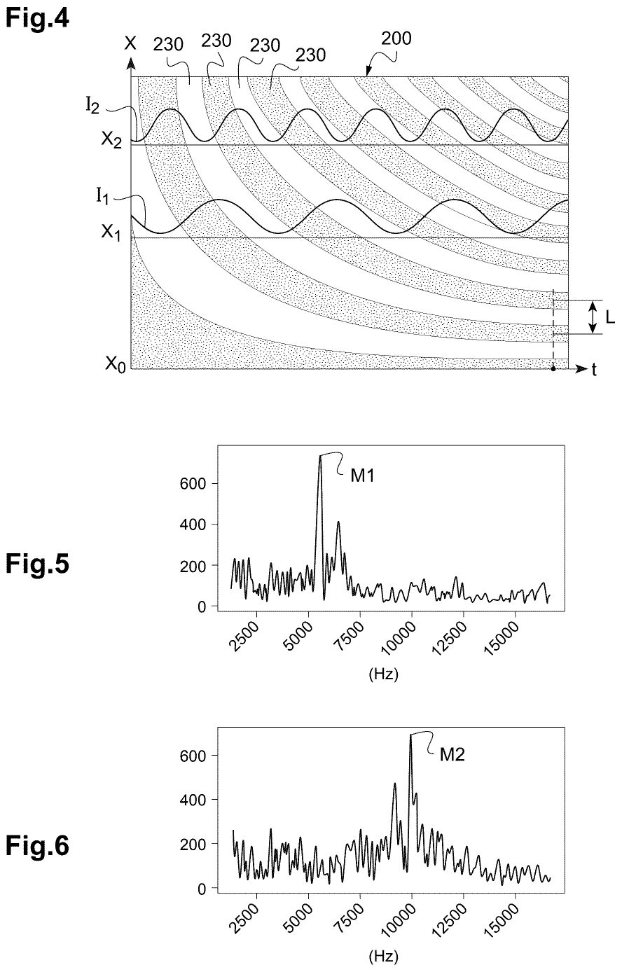

FIG. 4 is a schematic representation of a scrolling of interference fringes over time (t) produced by the device of FIG. 1 in projection along a main direction (X) at the level of the sample,

FIG. 5 is a first example of a frequency spectrum obtained for a particle at a first position along the main direction (X) of FIG. 4,

FIG. 6 is a second example of a frequency spectrum obtained for a particle at a second position along the main direction (X) of FIG. 4,

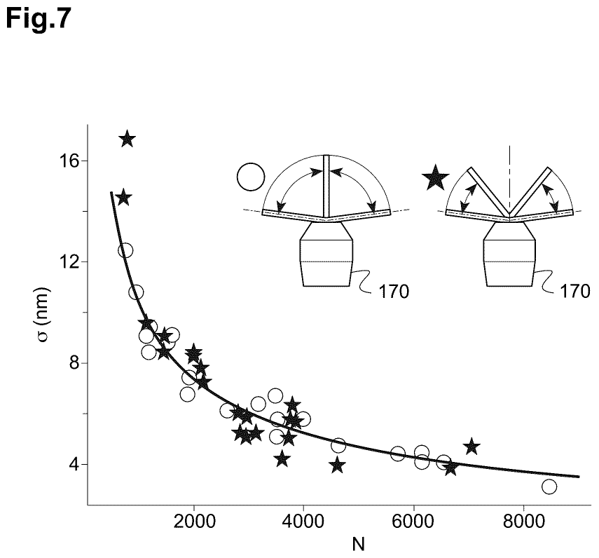

FIG. 7 is a graphical representation of the localization accuracy of the device of FIG. 1,

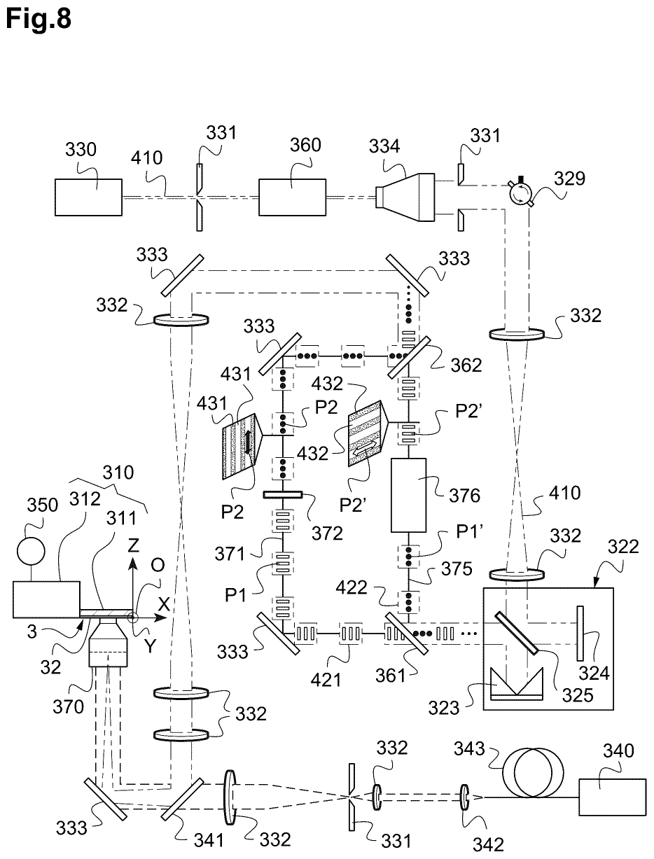

FIG. 8 is a schematic representation seen from above of a device for localizing an individualized particle in a sample according to the second embodiment,

FIG. 9 is a schematic perspective representation of interference fringes produced by the device of FIG. 8 at the level of the sample,

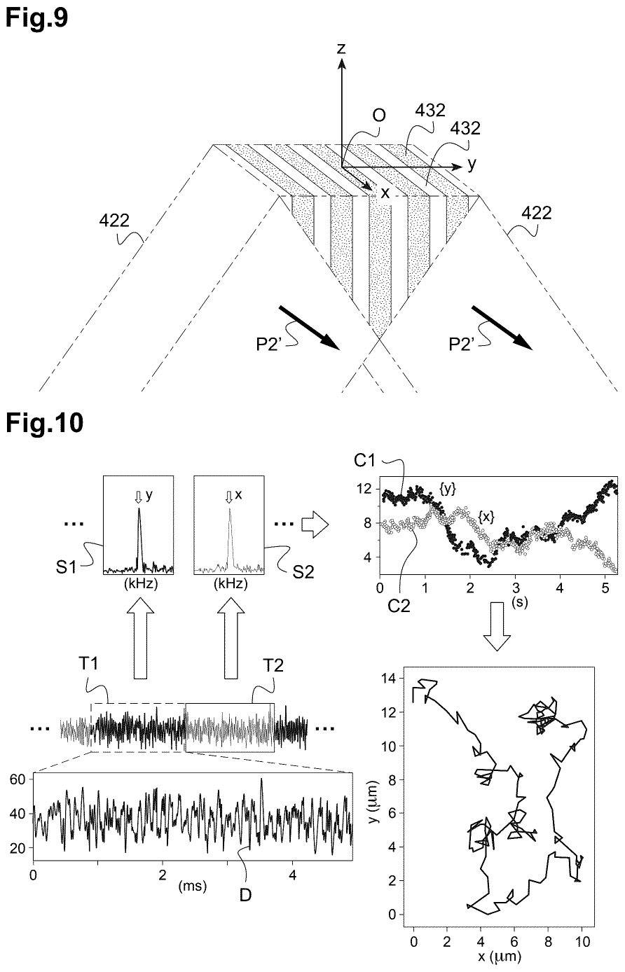

FIG. 10 is a schematic representation of the frequential treatment of a signal from the detector in order to determine the trajectory of a particle,

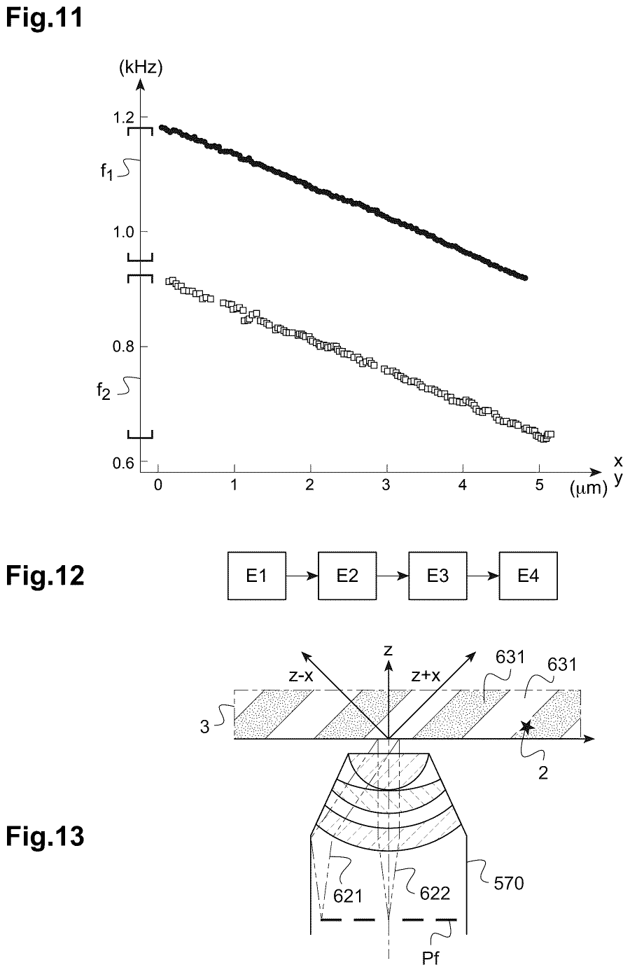

FIG. 11 is a graphical representation of scrolling frequencies of interference fringes produced by the device of FIG. 8 as a function of the position (x, y) of a particle in a first direction and in a second direction,

FIG. 12 is a block diagram of a sequence of steps of a method according to the invention allowing the localization of an individualized particle in a sample according to a main direction,

FIG. 13 is a schematic cross-sectional representation in a plane (O, X, Z) of the light beams incident on the sample through an objective of a device according to the invention and of oblique interference fringes produced by these beams within the sample.

In the following description, the corresponding or identical elements of each embodiment of the invention will be identified by the same reference signs, and will not be described in detail each time.

Two embodiments of a device 100; 300 for localizing an individualized particle 2 in a sample 3 having several regions 31 according to the invention are respectively represented in FIGS. 1 to 6 and 8.

The device 100; 300 is an imaging device allowing to localize the particle 2.

According to the invention, the device 100; 300 for localizing the particle 2 comprises:
a support 110; 310 for the sample 3,
a light source arranged to produce an illumination field 200; 400 adapted to illuminate the sample 3 placed on its support 110; 310, an intensity of the illumination field 200; 400 having a temporal and spatial variation, so that said intensity has, in each region 31 of the sample 3, a predetermined temporal pattern different from the temporal patterns of said intensity in the other regions;
a detector 140; 340 adapted to convert photons emitted by particle 2 in response to its illumination by the illumination field 200; 400 in a signal representative of the intensity of the illumination field 200; 400 received by particle 2;
a computer 150; 350 programmed to determine, on the basis of a temporal evolution of the signal from the detector 140; 340 and of the temporal and spatial variation of the intensity of the illumination field 200; 400, the region 31 of sample 3 in which the particle 2 is localized.

The particle 2 is for example a molecule, a group of molecules or a group of identical atoms. The particle 2 is here adapted to emit photons when it receives light. The particle 2, for example, has a linear response to the light it receives, which means that its photon emission is proportional to the intensity of the light it receives. The particle 2 may also have a non-linear response to the light it receives, notably when an excitation level of the particle 2 is close to the values associated with a saturation of the particle 2. That is for example the case when the particle used is a fluorophore and a photon absorption rate by particle 2 is of the same order of magnitude as the inverse of a fluorescence lifetime of particle 2.

The particle 2 is for example selected from the group comprising: the diffusing particles (such as a gold particle), the fluorescent particles, also called fluorophores, the phosphorescent particles, the quantum dots, the fluorescent proteins, the dye molecules. Here, the particle 2 has a size less than one micrometer. Therefore, device 100 is more specifically a microscopy device. Generally, the particle 2 preferably has a size between 1 nm and 40 nm.

The particle 2 is conventionally located in the volume of the sample 3 or on the surface of the sample 3. The sample 3 is at least partially transparent to light, particularly to the wavelengths generated by the device 100 and described below, so that the light reaches the particle 2.

As shown in FIGS. 1 and 8, the sample 3 is here thin in the sense that its thickness is significantly less than its width and length. As an example, the sample 3 is a slice or a section of a biological tissue. The sample 3 therefore extends substantially around a mean plane. The sample 3 has, for example, a thickness along the Z axis of FIG. 1 of between 10 micrometers (μm) and 100 μm and a length and/or width in the plane (OXY) of FIG. 1 greater than 1 centimeter (cm).

The regions 31 of the sample 3 are distinct portions of the sample 3, the set of portions forming the sample 3. The regions 31 may be point-like or extended. They may be extended in one, two or three dimensions. Each region 31 may, for example, correspond to a particular position within the sample 3. So, the term “region” comprises notably the notion of a point-like position defined by specific coordinates (x, y, z) in the (O, X, Y, Z) reference frame of FIG. 1. The term “region” can also refer, for example, to a plane extending in the directions Y and Z and intersecting the axis X at a special position.

The fact that the particle 2 is individualized means here that the particle is spatially separated from other particles by a distance greater than the resolution limit of the device according to the invention. In practice, here, this means that two neighboring particles 2 are at least 2 times, and preferably 5 times, apart from the resolution limit given by the diffraction which is approximately 1 μm. Two neighboring particles 2 are therefore, for example, at least 2 μm apart. This means, for example, that the region 31 containing the particle 2 does not comprise any other particle.

The support 110; 310 of the device 100; 300 is adapted to receive the sample 3. Here, the support 110; 310 more specifically comprises a blade 111; 311 extending along an extension plane.

Furthermore, the support 110; 310 is also adapted to move the sample 3 relative to the optical elements of the device 100; 300, notably relative to an objective 170; 370 bringing the light produced by the light source towards the support 110; 310. To this effect, the support 110; 310 comprises actuators 112; 312, for example piezoelectric ones, adapted to move the blade 111; 311 in its extension plane.

The sample 3 is placed on the blade 111; 311 so that the mean plane of the sample 3 extends parallel to the extension plane of the blade 111; 311.

The regions 31 of sample 3 can be defined discretely, for example so as to crisscross the sample 3 into rows and columns perpendicularly to its thickness. Each region 31 of the sample 3 can be associated with a corresponding area of the blade 111; 311 forming the support 110; 310, which is located opposite the region 31 when the sample 3 is placed on the support.

The regions 31 of the sample 3 can also be defined continuously. In this case, they are for example identified by coordinates, for example Cartesian coordinates, in a reference frame related to the support 110; 310. The reference frame related to the support 110; 310 comprises, for example, an orthogonal reference frame referenced OXYZ in FIGS. 1 and 8. In this orthogonal reference frame OXYZ, the thickness of the sample 3 is defined as the dimension of the sample 3 along the Z axis, the length of the sample 3 is defined as the dimension of the sample 3 along the X axis, and the width of the sample 3 is defined as the dimension of the sample 3 along the Y axis. The origin O of the orthogonal reference frame OXYZ is, for example, placed at one of the corners of the blade 111; 311 when the latter has the shape of a rectangle.

The light source of the device 100; 300 is partially shown in FIGS. 2, 3. It is also presented in full in FIG. 8 as part of the second embodiment of the device 300. It is arranged to produce an illumination field 200; 400 adapted to illuminate the sample 3 placed on the support 110; 310. The light source is therefore configured to illuminate the particle 2 which, in turn, emits photons.

The term “illumination field” 200; 400 here refers to the spatial distribution of the intensity of the light (i.e. the separate beams described later) emitted by the light source and conveyed to the sample 3. The intensity of the illumination field 200; 400 produced by the light source has a temporal and spatial variation.

Such a temporal and spatial variation of the intensity of the illumination field 200 is for example represented in FIG. 4 in the context of the first embodiment of the device according to the invention. As shown in FIG. 4, at each given instant t, the intensity of the illumination field 200 produced by the light source of the device 100 according to the invention has different values at different places in space corresponding here to different distances from the origin O of the orthogonal reference frame OXYZ (FIG. 1) along the X axis. Particularly, here, the intensity of the illumination field 200 has one or more maxima (represented by the white areas) and one or more minima (represented by the black areas) along this X axis.

The spatial variation of the intensity of the illumination field is different at each instant t, which leads to the temporal variation of this intensity.

The temporal variation of the intensity of the illumination field 200 is illustrated in FIG. 4 by a displacement of the one or more maxima and of the one or more minima over time. The intensity of the illumination field 200 is, for example, defined at the level of an upper surface 32 of the sample 3 which faces the light source. The intensity of the illumination field 200 can also be defined at the level of the plate 111.

As mentioned previously, whatever the embodiment of the device considered may be, the light source is particularly arranged so that the intensity of the illumination field 200; 400 has, in each region 31 of the sample 3, a predetermined temporal pattern different from the temporal patterns of intensity in the other regions 31 of the sample 3. In others words, each region 31 is associated bijectively with a temporal pattern of the illumination field 200; 400. The temporal variation of the illumination field 200; 400 attributes a specific temporal code to each zone of the plate 111; 311 forming the support 110; 310 and therefore to each region 31 of the sample 3.

For that, the light source is here precisely arranged relative to the support 110; 310 of the sample 3, for example relative to the zones of the plate 111; 311 or relative to the OXYZ reference frame. Once the sample 3 is placed on the support 110; 310, the light source is then arranged relative to the sample 3 itself by the correspondence between the support 110; 310 and sample 3.

Each temporal pattern is a variation of the intensity according to a predetermined pattern, or structure. Each temporal pattern is thus characterized by its temporal variation. Thus, for each region 31 of the sample, the intensity of the illumination field 200; 400 varies temporally in a specific and predetermined manner.

Each temporal pattern comprises, for example, a periodic variation of the intensity. For example, each pattern may be more specifically a sinusoidal temporal variation of the intensity, as described in detail later.

Advantageously, as will be clearly shown later, several regions 31 are illuminated concomitantly by the illumination field 200; 400, as opposed to a sequential illumination of each of the regions (one after the other, like a scan). In other words, each region 31 is illuminated by its temporal pattern, in the sense that it actually receives photons, at the same time as other regions 31 are illuminated by their respective temporal patterns. When the sample size allows it (because it is sufficiently small), all regions 31 of sample 3 are illuminated simultaneously by the illumination field 200; 400, which means that sample 3 is illuminated in its entirety. Generally, all the regions 31 of the sample 3 located in the field of view of the objective 170; 370 are illuminated simultaneously. Localization is therefore rapid since encoding is carried out in parallel for all regions.

To produce this temporal and spatial variation of the illumination field 200; 400, the light source particularly comprises a light emitter 130; 330 adapted to produce light and a set of optical elements arranged to generate the variation of illumination field 200; 400 from the light produced by the light emitter 130; 330 In the example of the first and second embodiments described here, this set of optical elements notably comprises an optical device for separating light beams 122; 322 adapted to divide the beam emitted by the light emitter 130; 330 into two light beams, a moving optical element and a converging optical element adapted to superimpose the two separated beams to make them interfere.

The light emitter 130; 330 (FIGS. 2, 3 and 8) is for example a laser, for example a diode laser. Here, the laser emits an initial light beam 210; 410 whose central wavelength (i.e. highest amplitude) is for example between 405 nm and 800 nm. The light emitter 130; 330 can be adapted to produce light continuously with a constant intensity. It can also be a pulsed light source, producing light at regular time intervals.

The detector 140; 340 (FIGS. 1 and 8) of the device 100; 300 according to the invention is adapted to convert the photons emitted by the particle 2 in response to its illumination by the illumination field 200; 400, into a signal. The signal is thus representative of the intensity of the illumination field 200; 400 received by the particle 2. The signal here is an electrical, digital or analog signal. The temporal variation of the signal comprises information on the temporal pattern of the light beam which illuminated the particle 2.

The amplitude of the signal produced by the detector 140; 340 is particularly representative of a number of photons emitted by the particle 2 in response to its illumination by the illumination field 200; 400 per unit of time. For example, when the particle 2 has a linear response to the light it receives, the amplitude of the signal is then proportional to the intensity of the illumination field 200; 400 received by the particle 2.

The detector 140; 340 here has a sampling frequency greater than 1 MHz. The detector is for example selected from the group comprising: the single-detectors, the single-detector arrays, the detectors comprising single-photon avalanche diodes, the event-driven detectors whose pixels generate signals in response to a change in received light intensity, the neuromorphic detectors. A single-detector is defined as a detector comprising a single photosensitive element (for example a single pixel), it therefore does not have intrinsic spatial resolution.

The device 100; 300 may also comprise a set of optical elements for shaping and directing the light beam(s).

As shown especially in FIG. 8, the optical shaping elements comprise for example one or more diaphragms 331, as well as one or more optical lenses 332 and a beam expander 334. Each diaphragm 331 makes it possible to eliminate stray light from the light beam. The optical lenses 332 make it possible to shape the beam: adjust its diameter, focus it at a specific location or create a parallel beam. The optical elements for orienting the beam(s) comprise for example mirrors 333.

These optical elements being well known to those skilled in the art, they will not be described in detail in the remainder of the description.

The device 100; 300 further comprises a dichroic mirror 141; 341 (FIGS. 1 and 8) arranged to, on the one hand, reflect the light produced by the light emitter 130; 330 to direct it towards the support 110; 310 and the sample 3 and, on the other hand, transmit the photons emitted by the particle 2 towards the detector 140; 340.

The device 100 also comprises a recovery lens 142; 342 which focuses the photons emitted by the particle 2 towards the detector 140.

In the first embodiment shown in FIG. 1, the light beam coming from the recovery lens 142 is directly received by the detector 140. In the second embodiment shown in FIG. 8, the device 300 further comprises an optical fiber 343. The recovery lens 342 focuses the photons emitted by the particle 2 at the input of this optical fiber 343, the optical fiber 343 guiding them to the detector 340.

In FIGS. 1 and 8, the path of the photons emitted by particle 2 to the detector 140; 340 is represented schematically by a wide light beam whose envelope is represented by short and long dotted lines (two short, one long) while the light beams produced by the light source have an envelope represented by regular dotted lines. This representation of the light beams going towards sample 3 in short and long dotted lines also appears in FIGS. 2, 3, 9, and 13.

The device 100; 300 according to the invention finally comprises a computer 150; 350 programmed to analyze the signals produced by the detector 140; 340.

The computer 150; 350 here comprises at least one memory and at least one processor. The memory is a computer-readable recording medium comprising instructions which, when executed by the processor, make it possible to localize the particle 2. Localizing the particle means in particular determining the region 31 of the sample 1 in which the particle 2 is located.

The computer 150; 350 is particularly programmed to determine, on the basis of a temporal evolution of the signal and the temporal and spatial variation of the intensity of the illumination field 200; 400, that is to say on the basis of the predetermined temporal patterns, the region 31 of the sample 3 in which the particle 2 is localized.

Indeed, as explained above, each region 31 of the sample 3 is associated bijectively with a temporal pattern of the illumination field 200; 400. The signal emitted by the detector 140; 340 is representative of the intensity of the illumination field 200; 400 received by the particle 2. The temporal evolution of the signal emitted by the detector 140; 340 is therefore associated with a temporal pattern of the illumination field 200; 400 and consequently with a region 31. The computer 150 ; 350 is thus programmed to analyze the temporal evolution of the signal emitted by the detector 140; 340, to recognize one of the predetermined temporal patterns therein, and to determine the region 31 associated with this temporal pattern, that is to say the region 31 in which particle 2 is located. The computer 150; 350 here identifies the regions 31 of the sample relative to the support 110, for example via the different zones of the plate 111; 311 of the support 110; 310, or, as in the embodiments described later, by means of the OXYZ marker linked to the support 110; 310.

Here, the computer 150; 350 is also programmed to control the light source. Alternatively, the light source comprises a dedicated computer. This dedicated computer then transmits the relevant information, particularly about the predetermined temporal patterns, to the computer so that the latter can localize the particle 2.

The implementation of the device 100; 300 here makes it possible to implement a method of localizing the particle 2. As shown in FIG. 12, this method according to the invention comprises the following steps:
E1—arrangement of the sample 3 on the support 110; 310;
E2—production of illumination field 200; 400 by the light source, and illumination of sample 2 by the illumination field 200; 400;
E3—conversion, by the detector 140; 340, of the photons emitted by the particle 2 in response to its illumination by the illumination field 200; 400 so as to generate the signal;
E4—determination, on the basis of the temporal evolution of the signal and of the temporal and spatial variation of the intensity of the illumination field 200, of the region 31 of sample 3 in which particle 2 is localized.

In order to better understand the invention, a first embodiment of the device 100 allowing to localize the particle 2 along a main direction is first described. This first embodiment is described with reference to FIGS. 1 to 6.

This main direction here corresponds to the direction of the movement of the interference fringes which create the predetermined temporal patterns, as explained later. So, according to this first embodiment, the illumination field 200 produced by the light source has predetermined temporal patterns aligned along the main direction.

In this first embodiment, the main direction is parallel to the X axis of the OXYZ reference frame. Therefore, the main direction is significantly parallel to the mean plane of sample 3. Each region 31 thus extends over the entire width of sample 3, i.e. over its entire dimension along Y, and over the entire thickness of the sample 3, i.e. over its entire dimension along Z.

In this first embodiment, the regions 31 are thus also aligned along the main direction. The regions 31 are defined continuously. Each region 31 corresponds to an abscissa, referenced x, according to the X axis and which can take a real value. Each region 31 of the sample 3 is therefore characterized by a distance between this region 31 and a reference position along the main direction. The reference position is preferably the origin O of the OXYZ reference frame.

So, the localization of the particle 2 according to a main direction corresponds here to the localization of the particle 2 according to the X axis. By the following, reference is therefore made to the localization of the particle 2 along the X axis, i.e. to the determination of the abscissa of the particle 2.

The length of the sample 3 (therefore along the X axis) along which the particle 2 is detectable is here greater than 500 nm and preferably greater than 1 um. In others words, the regions 31 extend over a length greater than 500 nm and preferably greater than 1 μm. This length depends in particular on the portion of the sample 3 located in the field of observation of the detector 140.

According to a first exemplary embodiment of the optical separation device 122 of the light source of the first embodiment, this one comprises a device of the interferometer type arranged to separate the initial light beam 210 into two separate light beams 221, 222 as shown in FIG. 2. These two separate light beams 221, 222 are superimposed using an objective 170, to make them interfere with each other so as to form the interference fringes 230.

The illumination field 200 is then formed by these interference fringes 230. The interference fringes 230 are schematically represented in FIG. 4. In this Figure (as well as in FIGS. 8, 9, and 13), the half-period of a given interference fringe which comprises the maximum intensity of said fringe contains points while the half-period that comprises the minimum intensity does not contain any point. The numerical references indicating the interference fringes point to one type of half-period as well as to the other. The interference fringes 230 here extend along the Y axis, i.e. perpendicular to the X axis. As FIG. 4 clearly shows, the illumination field 200 simultaneously illuminates several X abscissae (that means several regions 31).

In the example shown in FIG. 2, the optical device for separating light beams 122 comprises a wedge mirror 123 having two perpendicular reflecting surfaces, a plane mirror 124 and a semi-reflecting blade 125 which are arranged as in a Michelson interferometer used in air wedge mode.

As shown in FIG. 2, the initial beam 210 is divided, here in equal parts, by the semi-reflecting blade 125 to form the two separate light beams 221, 222. The separate light beam 210 is, on the one hand, transmitted by the semi-reflecting blade 125 into a first separate light beam 221. This first separate light beam 221 is reflected in parallel by the wedge mirror 123, then by the semi-reflecting blade 125 towards the support 110. The initial beam 210 is, on the other hand, reflected by the semi-reflecting blade 125 into a second separate light beam 222. This second separate light beam 222 is reflected by the plane mirror 124 to be transmitted towards the support 110 by the semi-reflecting blade 125.

In the example shown in FIG. 3, the optical device for separating the light beam 122 is formed by a separating cube 126 having a semi-reflective internal diagonal surface 127. The separating cube 126 is for example made of glass. As shown in FIG. 3, the separating cube 126 is oriented so that the semi-reflective internal diagonal surface 127 is parallel to the initial beam 210 before it enters the separating cube 126. The initial beam 210 is divided, here equally, by the semi-reflective internal diagonal surface 127 to form two separate light beams 221′, 222′. The latter then emerge parallel to each other from the separating cube 126.

In all cases, the converging optical element of the light source comprises here the objective 170 which is provided with a converging lens 128 arranged to make the two separate beams 221, 222; 221′, 222′ converge towards the support 110 to make the two separate light beams 221, 222; 221′, 222′ interfere so as to produce the interference fringes 230 (FIG. 4) at the level of sample 3 placed on its support 110.

The movable optical element is arranged so that its movement causes the interference fringes 230 to scroll. The movement of the movable optical element is here controlled by the computer 150.

This scrolling of the interference fringes 230 then forms the temporal patterns. Thus, the temporal variation of the illumination field 200 results from the movement of the movable optical element.

The movable optical element here is a rotating mirror and particularly a galvanometric mirror 129. The movement of the movable optical element is therefore a rotation of the galvanometric mirror 129, which is shown diagrammatically by the curved arrows in FIGS. 2 and 3.

The galvanometric mirror 129 is suitable for varying over time the incidence angle α of each separate light beam 221, 222; 221′; 222′ on the sample 3 placed on its support 110. That is advantageous because the cost of a galvanometric mirror 129 is high.

For this purpose, the galvanometric mirror 129 is placed upstream of the beam separating device 122. In others words, as illustrated in FIGS. 2 and 3, the galvanometric mirror 129 makes it possible to orient, i.e. to modify the direction and/or translate, the initial light beam 210. The galvanometric mirror 129 is for example arranged so that the initial light beam 210 is incident at the level of the rotation axis of the galvanometric mirror 129.

In a particularly advantageous manner, a rotation of the galvanometric mirror 129 varies the angles of incidence a of the separate light beams. 221, 222; 221′, 222′ simultaneously and in opposite directions. So, the position of the optical contact at the level of the sample 3 is invariant over time despite the rotation of the galvanometric mirror 129.

In the example of FIG. 2, this effect is obtained in particular thanks to the wedge mirror which makes it possible to return the first separated light beam 221. In this example, when the galvanometric mirror 129 rotates clockwise, the separated light beams 221, 222; 221′, 222′ deviate from each other symmetrically.

In the example of FIG. 3, a lens 143 is placed between the galvanometric mirror 129 and the separating cube 126 to fix the angle of incidence of the initial light beam 210 on the separating cube 126 despite the rotation of the galvanometric mirror 129. In this example, when the galvanometric mirror 129 rotates in the counterclockwise direction, for example to move from the position referenced R1 to the position referenced R2, the separated light beams 221, 222; 221′, 222′ move away from each other symmetrically, which is represented by arrows of the same length.

The operation of the first embodiment of device 100 makes it possible to implement the method of localizing the particle 2 along the X axis by determining its abscissa.

In this first embodiment, the step E2 of producing the illumination field 200 and of illuminating the sample 3 by the illumination field 200 comprises the rotation of the galvanometric mirror 129.

This rotation causes an identical variation of the angles of incidence α of the separated light beams 221, 222; 221′, 222′ on the sample 3 and therefore a scrolling of the interference fringes 230. At a given rotation speed, the interference fringes 230 scroll specifically with a scrolling speed which depends on the distance from the optical contact, at which the phase shift between the separate light beams 221, 222; 221′, 222′ is zero, along the X axis. The farther a region 31 is from the optical contact, the faster the interference fringes 230 which illuminate it, scroll.

In FIG. 4, the optical contact is positioned at the abscissa referenced xo. The optical contact thus defines the reference position along the X axis (so along the main direction). As explained previously, the abscissa x₀ of the optical contact is invariant during rotation because the angles of incidence α of the separate light beams 221, 222; 221′, 222′ vary simultaneously and in opposite directions. This is schematically represented in FIG. 4 by a maximum and constant light intensity over time at the abscissa x₀ of the optical contact.

The galvanometric mirror 129 here rotates at a constant rotation speed (apart from a start phase and a stop phase). This regular rotation implies that each temporal pattern is a periodic, and specifically sinusoidal, temporal variation of the intensity of the illumination field 200 at a specific frequency. In other words, each region 31 sees the interference fringes 230 scroll regularly. Therefore, for each region 31, the intensity of the received illumination field 200 varies sinusoidally.

All specific frequencies are related by the same relationship to the distance between the position of their associated time pattern, i.e. the abscissa x of their associated region 31, and the optical contact along the main direction. The specific frequencies are therefore all related here by the same relationship to the value x−x₀.

Here, this relationship is particularly a relationship of proportionality. This means that each region 31 sees the interference fringes 230 scroll at a specific frequency which is proportional to the abscissa x of the said region 31. So, by noting I the intensity of the illumination field 200, and by attributing the value zero to the abscissa x₀, for a given region 31 of abscissa x, the intensity I varies over time t according to the formula (1): I(x, t)∝1+cos(a·t·x), where a is a coefficient of proportionality which depends in particular on the rotation speed of the galvanometric mirror 129.

Thus, the rotation of the galvanometric mirror 129 at a constant speed of rotation implies that each temporal pattern is a sinusoidal variation of the intensity of the illumination field 200 at a specific frequency which is proportional to the abscissa of the region 31 associated with said temporal pattern.

Such scrolling is illustrated in FIG. 4 in which a first region 31 of abscissa x₁ is located closer to the optical contact (abscissa x₀) than a second region 31 of abscissa x₂, which means that x₂>x₁. In the time interval shown in FIG. 4, the first region 31 sees approximately four interference fringes 230 pass by and the second region 31 approximately six interference fringes 230. Therefore, the intensity I2 received by the second region 31 varied at a specific frequency higher than that of the intensity I1 received by the first region 31, the specific frequencies being respectively proportional to the abscissae x₂ and x₁.

As illustrated in FIG. 4, the distance measured along the X axis on which the particle 2 is detectable is here greater than the interfringe L at at least a given moment, during the rotation of the galvanometric mirror 129. Preferably, the distance measured along the X axis on which the particle 2 is detectable is greater than the interfringe L during a given time interval, for example, at all times beyond a reference time. This distance is for example here greater than the distance x₂−x₀ along the X axis of FIG. 4. In other words, the regions 31 extend over a length greater than the interfringe L at at least one given instant during the rotation of the galvanometric mirror 129, preferably over a given time interval. This means that at said given instant or in the given time interval, the regions 31 are illuminated by more than one interference fringe 230, preferably by several interference fringes.

Here, during step E2, the galvanometric mirror 129 particularly performs oscillations, that is to say rotations in one direction and in the other. In one direction of rotation, new interference fringes 230 appear on the sample 3 over time, as is the case in FIG. 4, in the other direction of rotation, the interference fringes 230 come out of the sample 3 over time. In both cases, the interference fringes 230 scroll at specific frequencies.

The amplitude of these oscillations is for example less than 5 degrees. A rotation of the galvanometric mirror 129 is for example performed in a time interval between 10 ms and 100 ms. The oscillation frequency of the galvanometric mirror 129 is then between 10 Hz and 5000 Hz.

The scrolling frequency of the interference fringes 230 is therefore several orders of magnitude higher than the oscillation frequency of the galvanometric mirror 129, which makes it possible to localize the particle 2 very quickly. Indeed, as that appears below, it is preferable for the particle 2 to be illuminated by several periods of the time pattern to obtain a precise determination of its localization.

The specific frequencies, i.e. the frequencies of the interference fringes 230, can for example be as high as 1 MHz.

After the conversion of the photons issued by the particle 2 to form a signal, in step E3, the computer 150 analyzes the temporal evolution of the signal in step E4.

Here, the step E4 specifically comprises the realization by the computer 150 of a Fourier transform of the signal. This makes it possible to determine the frequencies contained in the signal.

As a reminder, the temporal evolution of the signal is representative of the temporal pattern which illuminated the particle 2. For example, when the particle 2 is located at the abscissa x₁, the temporal evolution of the signal is representative of the intensity I1 in the sense that the signal varies mainly at the same frequency as the intensity I1.

The Fourier transform thus makes it possible to determine the specific frequency associated with said temporal pattern.

In practice, the Fourier transform has a peak, i.e. a maximum M1, M2, corresponding to the specific frequency of said temporal pattern which illuminates the particle 2.

The computer 150 then determines the region 31 in which the particle 2 is located. In this first embodiment, it can be deduced from the formula (1) that the specific frequency, noted f, of the pattern which illuminates the particle located at the abscissa x is given by: f=a·x. The abscissa x of the region 31 in which the particle 2 is located is therefore given by x=f/a. The coefficient a is for example determined by moving the sample 3, and therefore the particle 2, in translation along the X axis by means of the actuators 112. That in effect makes it possible to determine the coefficient a by solving a system of two equations with two unknowns.

In other words, on the basis of the specific frequency, the computer 150 recognizes the temporal pattern which illuminates the particle 2. Then, each region 31 being associated bijectively with a temporal pattern, the computer 150 determines the region 31 in which the particle 2 is located.

For example, when the particle 2 is located at the abscissa x₁ in FIG. 4, the Fourier transform of the signal can in practice have a frequency spectrum as illustrated in FIG. 5. In comparison, when the particle 2 is located at the abscissa x₂ in FIG. 4, the Fourier transform of the signal can in practice have a frequency spectrum as illustrated in FIG. 6. The frequency spectrum in FIG. 6 has a maximum M2 at a frequency approximately twice that of the maximum M1 of the spectrum in FIG. 5, which derives from the fact that abscissa x₂ is approximately twice the abscissa x₁ (here because the relationship between the specific frequencies and the abscissae is a relationship of proportionality). In FIGS. 5 and 6, the peaks at mid-height of the referenced maxima M1 and M2 correspond here to a second particle positioned at another abscissa.

The specific frequency can be determined very precisely thanks to the high sampling frequency of the detector 140. Preferably, several periods of variation of the intensity of the illumination field 200, for example more than four, are detected by the detector 140 in order to increase the determination of the specific frequency. Thus, the faster the interference fringes 230 pass, the more precise the determination of the specific frequency in a given time is (since more periods are detected).

This very precise determination of the specific frequency therefore allows a near-precise determination of the abscissa x of the particle 2 by the formula x=f/a mentioned above. In this sense, the method of localizing the particle 2 is therefore a super-resolution method.

FIG. 7 graphically compares experimentally obtained particle localization accuracies, expressed by standard deviations o depending on the number of photons N detected, to the theoretical Cramer-Rao bound (solid line) for a signal-to-noise ratio equal to that of the experimental measurements (here one). The experimental accuracies are represented by circles or stars depending on the collection angle used to capture the light reflected by the sample 3 (see top right of FIG. 7). As shown in FIG. 7, the experimental accuracies are very close to the theoretical limit, which illustrates well the super-resolution of the method of localizing.

The method implemented in this first embodiment also makes it possible to localize several particles present in the sample 3 along the X axis. For example, when two particles 2 are positioned at the abscisse x₁ and x₂, as shown in FIG. 4, the signal is representative of both the intensity I1 and the intensity I2. Then, the frequency spectrum of the signal has two peaks: one at the variation frequency of I1 and the other at the variation frequency of I2. The computer 150 then determines the two abscissae corresponding to the two specific frequencies detected. When the number of particles is not predetermined, the peaks are for example distinguished from noise by appropriate thresholding.

As a variant of this first embodiment, the galvanometric mirror can rotate at a non-constant speed. Then, the time patterns are not sinusoidal variations. A pattern could for example be a sinusoid of which the specific frequency increases over time. Many time patterns can be produced by adapting the rotation of the galvanometric mirror. The computer is then also programmed to recognize these time patterns, for example in having in memory all the time patterns which are predetermined, in order to determine the region in which the particle is located.

Until here it has been described how to localize the particle 2 in one dimension (here according to the X axis). The device 100 allows, however, to localize the particle in two dimensions, i.e. along the main direction and along a secondary direction distinct from the main direction.

For this purpose, it is possible, for example, to implement another light source functioning alternately with the light source, meaning that they illuminate the sample 3 in turn. The other light source is adapted to localize the particle 2 according to the secondary direction by means of another illumination field having another spatial and temporal variation.

Advantageously, it is also possible to localize the particle 2 in two dimensions, without using two light sources alternately illuminating the sample.

According to the second embodiment of the device 300 shown in FIG. 8, the localization of the particle 2 is made in two dimensions by means of a unique light source.

The idea of this second embodiment is to polarize the illumination field 400 in two distinct polarization directions.

In this second embodiment, the secondary direction is parallel to the Y axis of the XYZ reference frame. Thus, the main direction and the secondary direction are orthogonal.

In this second embodiment, each region 31 extends over the entire thickness of the sample 3, i.e. over its entire dimension along Z. The regions 31 are thus distributed so as to crisscross the surface of the sample 3. The regions 31 are defined continuously. Each region 31 is characterized by an abscissa, referenced x, along the X axis and an ordinate, referenced y, along the Y axis which can have a real value.

The localization of the particle 2 along a secondary direction is here equivalent to the localization of the particle 2 along the Y axis. Subsequently, reference is therefore made to the localization of the particle 2 along the Y axis, i.e. to the determination of the y-ordinate of the particle 2. Here, the particle 2 is therefore localized in the XY plane.

The surface area of the XY plane in which the particle 2 is detectable is here greater has 500×500 nm² and preferably greater than 1 μm². In others words, the regions 31 extend over a surface greater than 500×500 nm ² and preferably greater than 1 μm². This surface depends essentially on the portion of the sample 3 localized in the observation field of the detector 140. This surface is here also greater than the square of the interfringe at at least one given instant during the rotation of the galvanometric mirror 129.

In this second embodiment, the illumination field 400 can be polarized according to a first polarization direction, the illumination field 400 then makes it possible to localize the particle 2 along the X axis. This means that, according to the first polarization direction, the illumination field 400 has a first intensity which varies spatially and temporally so as to allow the localization of the particle according to the main direction in accordance with the first embodiment.

The illumination field 400 can also be polarized according to a second polarization direction, here orthogonal to the first one, the illumination field 400 then makes it possible to localize the particle 2 along the Y axis. This means that, according to the second polarization direction, the illumination field 400 has a second intensity which varies spatially and temporally so as to allow the localization of the particle according to the second main direction in accordance with the first embodiment.

Here, the first polarization direction of the illumination field 400 is, at the level of the sample 3, orthogonal to the main direction. The first polarization direction is more specifically parallel to the Y axis. The second polarization direction of the illumination field 400 is, at the level of the sample 3, parallel to the main direction. The second polarization direction P2′ is more specifically parallel to the X axis (FIG. 9). Thus, each polarization direction, for example the second polarization direction P2′ in FIG. 9, is orthogonal to the plane in which the separate light beams 422 propagate, i.e. the YZ plane in the case of FIG. 9.

So, the polarizations are parallel to the interference fringes 430. This makes it possible to maximize the contrast of the interference fringes. In other words, the first intensity has first temporal patterns generated by a scrolling of first interference fringes 431 extending rectilinearly parallel to the first polarization direction, and, conversely, the second intensity has second temporal patterns generated by a scrolling of second interference fringes 432 extending rectilinearly parallel to the second polarization direction (FIG. 9).

For this purpose, in practice, the light source of the device 300 according to the second embodiment comprises, as in the first embodiment described previously, a light emitter 330, a beam separating device 322 and a movable optical element.

The light emitter 330 comprises a laser source and the movable optical element comprises a galvanometric mirror 329.

The optical light beam separating device 322 comprises, as in the first embodiment, a wedge mirror 323 having two perpendicular reflecting surfaces, a plane mirror 324, and a semi-reflecting blade 325 arranged in a Michelson interferometer type configuration.

These elements are similar to those of the first embodiment and will not be described in further detail here.

As shown in FIG. 8, the light source of the second embodiment further comprises:
a polarization modulator 360; and
a first polarizing cube 361 and a second polarizing cube 362.

The polarization modulator 360 is placed between the light emitter 330 and the galvanometric mirror 329. The polarization modulator 360 is adapted to polarize the initial beam 410 according to the first polarization direction and/or the second polarization direction. This modulator can be an electro-optical modulator such as a Pockels cell or a magneto-optical modulator such as a Faraday cell.

The first polarizing cube 361 is placed downstream of the optical light beam separating device 322 so as to direct the separated light beams 421 polarized according to the first polarization direction towards a first optical path 371 and the separated light beams 422 polarized according to the second polarization direction towards a second optical path 375. By rotating the polarization of the initial beam 410 between the first polarization direction and the second polarization direction, the polarization modulator 360 makes it possible to select the first optical path 371 and the second optical path 375 respectively.

Along the first optical path 371, the polarization is initially orthogonal to the interference fringes 330. The light source comprises a half-wave blade 372 arranged on the first optical path 371 so as to turn the polarization by 90 degrees perpendicular to the direction of propagation. Thus, at the level of the sample 3, the first polarization direction is parallel to the first interference fringes 431. This rotation of the polarization is shown diagrammatically in FIG. 8 by the transition from a horizontal polarization P1 to a vertical polarization P2. As also shown in FIG. 8, along the first optical path 371, the polarization and the first interference fringes 430 are vertical after the half-wave blade 372.

Along the second optical path 375, it is necessary to turn the second interference fringes 432 by 90 degrees so that they extend perpendicular to the first interference fringes 431 so as to allow the localization along the Y axis. For this purpose, the light source comprises a Dove prism type assembly 376 arranged on the second optical path 375 so as to turn the second interference fringes 432. The polarization is itself turned by the polarization modulator 360 when it polarizes the initial beam according to the second polarization direction. This rotation of the polarization, which also makes it possible to select the second optical path 375, is shown diagrammatically in FIG. 8 by the transition from a vertical polarization P1′ to a horizontal polarization P2′.

The Dove prism type assembly 376 here is a reflecting prism made by using mirrors. This avoids introducing additional birefringence. Typically, two mirrors are arranged at 45 degrees to the direction of propagation and a third, between these two mirrors, is arranged parallel to the direction of propagation.

Finally, the second polarizing cube 362 recombines the two polarizations, i.e. the light beams from the two optical paths 371, 375, before the illumination field 400 illuminates sample 3.

The operation of the second embodiment of the device 100 makes it possible to implement the method of localizing the particle 2 described previously according to the main direction and according to the secondary direction, which here amounts to determining its abscissa x according to the X axis and its ordinate y according to the Y axis.

For this purpose, the illumination field 400 can be polarized according to the first polarization direction and according to the second polarization direction sequentially or simultaneously.

When the polarizations of the illumination field 400 are implemented sequentially, i.e. alternately, the sample 3 is illuminated either by the first interference fringes 431 or by the second interference fringes 432. The polarization modulator 360 therefore makes it possible to select the direction of localization of the particle 2 in the sense that it makes it possible to choose between a localization along the X axis and a localization along the Y axis. The information on an instantaneous polarization of the illumination field 400, that means the fact that the illumination field 400 is polarized along the first polarization direction or along the second polarization direction, is transmitted from the polarization modulator 360 to the computer 350. The computer 350 is then programmed to determine, on the basis of this information on the polarization of the illumination field at time t, that the specific frequency that it detects in the frequency spectrum at the time t, applies to the localization along the X axis, i.e. to the determination of the abscissa of particle 2, or that the specific frequency it detects in the frequency spectrum at the moment t, applies to the localization according to the Y axis, i.e. to the determination of the ordinate of particle 2.

FIG. 10 illustrates a two-dimensional tracking (along the X and Y axes) of a fluorescent nanoparticle in a Brownian random motion in a liquid. Specific frequencies associated with each X, Y axis are alternately extracted from the signal (referenced D at the bottom left of FIG. 10) coming from the detector. Time sections T1, T2 of the signal alternately encode the position of the particle along each X, Y axis. In FIG. 10, two successive time sections T1, T2 are framed, a first section T1 coding for the Y axis and the following one T2 for the X axis (the section T1 is also represented enlarged). The frequency spectrum S1, S2 of each time section T1, T2 makes it possible to determine the specific frequency of this section (top left of FIG. 10, pointed by an x or y arrow). The temporal evolution of the specific frequencies can then be represented by the time-frequency curves C1, C2. In the top right of FIG. 10, the time-frequency curve referenced C1 is relative to the Y axis while the time-frequency curve referenced C2 is relative to the X axis. The temporal evolution of the specific frequencies makes it possible to deduce the position of the particle over time along the X and Y axes, that means the path of the particle, as shown at the bottom right of FIG. 10.

When the polarizations of the illumination field 400 are implemented simultaneously, the sample 3 is illuminated by both the first interference fringes 431 and the second interference fringes 432.

The signal detected by the detector 340 is then representative at the times of scrolling of the first interference fringes 431 and of scrolling of the second interference fringes 432. The frequency spectrum then comprises two peaks: a first peak corresponding to the scrolling frequency of the first interference fringes 431 (that means a first frequency specific to the first pattern that illuminates the particle 2) and a second peak corresponding to the scrolling frequency of the second interference fringes 432 (that means a second frequency specific to a second pattern which illuminates particle 2).

Preferably, the scrolling frequencies of the first interference fringes 431 (that means of the first frequencies specific to the first temporal patterns) are distinct from the scrolling frequencies of the second interference fringes 432 (that means of the second frequencies specific to the second temporal patterns). Thus, as shown in FIG. 11, the scrolling frequencies of the first interference fringes 431 belong to a first frequency range f1 that is disjoint (here superior) of a second frequency range f2 of the scrolling frequencies of the second interference fringes 432.

Thus, the computer 350 can unambiguously attribute each of the two peaks of the frequency spectrum, that means the specific frequencies, either to a scrolling frequency of the first interference fringes 431 when the peak belongs to the first frequency ange f1, or to a scrolling frequency of the second interference fringes 432 when the peak belongs to the second frequency range f2. Therefore, the computer 350 can determine for each peak whether the latter corresponds to an abscissa or to an ordinate of the particle 2.

For this purpose, each optical path 371, 375 can be adjusted independently so as to adjust the position of the optical contact for each one of the polarization directions. Modifying the position of the optical contact in effect makes it possible to shift the frequency ranges. This is achieved, for example, by moving the sample 3 using the actuators 112 or by modifying the orientation of one of the mirrors 333 of the optical elements for orienting the light beam(s).

The method implemented by the device 300 according to the second embodiment also makes it possible to localize several particles present in the sample 3 in the XY plane. For example, with two particles, the computer 350 performs the matching of an abscissa with an ordinate on the basis of the time intervals during which the particles 2 emit photons. Indeed, the two particles illuminate at different times due to the stochasticity of appearance of the emission of particles observed in sparse regime, that is to say when there is a single particle 2 in a diffraction volume which ensures that the diffraction spots corresponding to two different particles of the sample can be separated. This can be obtained either spontaneously or by inducing an optical and/or chemical control of the particles. In others words, the emission of photons by each particle occurs with a random time lag after its illumination. The emissions of photons of the particles of the sample are therefore randomly offset from each other, which gives the impression that they are flashing.

Thus, when the polarizations of the illumination field 400 are implemented simultaneously, at a given instant, the frequency spectrum comprises only the specific frequencies of a single particle, which can therefore be localized in the XY plane. Each frequency spectrum that is analyzed by the computer 350 is for example obtained by a Fourier transform of the signal performed over a period of 50 ms. When the polarizations of the illumination field 400 are implemented sequentially, the alternation between the two polarizations is performed at a high rate to have an alternation at least once, and preferably several times, during the time interval during which a particle emits photons. The alternation is for example performed every 25 ms and each analyzed frequency spectrum is for example obtained by Fourier transform performed over a period of 50 ms of the signal.

Preferably, to individualize the particles in the sample 3, sample 3 comprises a concentration of simultaneously emitting particles of less than 1 particle/μm³. With such a concentration, the particles then appear sparse in the sample 3 when they emit.

So far it has been described how to localize particle 2 in one dimension (first embodiment) or two dimensions (second embodiment). However, the invention also makes it possible to localize the particle in three dimensions, i.e. along the main direction and the secondary direction and along a third direction that is not coplanar with the other two. The third direction is here parallel to the Z axis of the XYZ frame. Thus, the main direction, the secondary direction, and the third direction are orthogonal. Here, the particle 2 is therefore localized in the XYZ frame.

For this purpose, it is for example possible to implement a system combining the device 300 according to the second embodiment, so as to localize the particle 2 in the XY plane, with the device 100 according to the first embodiment but oriented so that its main direction is parallel to the Z axis, which means here that the latter illuminates the sample 3 through its edge with incident beams parallel to the XY plane.

Advantageously, it is provided here to adapt the device 300 according to the second embodiment by redividing one of the polarizations, i.e. by redividing one of the optical paths 371, 375. This makes it possible to use a single laser, a single galvanometric mirror and a single optical beam separation and convergence device.

For this purpose, the first optical path 371 comprises for example a third polarizing cube dividing the polarization of this first optical path 371 in two. The two new polarizations are recombined before illuminating the sample. 3. That makes it possible to localize along the Z axis (i.e. in thickness) by means of interference fringes oblique to the Z axis.

The idea is for example to tilt interference fringes in the Z+X direction and other interference fringes in the Z−X direction. FIG. 13 illustrates the interference fringes 631 tilted in the Z+X direction. For that, the separated light beams 621, 622 of each new polarization (the one along Z+X in FIG. 13) are spatially separated from each other in the rear focal plane Pf of the objective 570. In practice, the separated light beams 621, 622 are off-centered with respect to the axis of the objective 570 in the rear focal plane Pf. Indeed, as illustrated in FIG. 13, the angle of incidence of one of the two separated light beams 621, 622 on sample 3 depends on its position in the rear focal plane Pf. Its deviation from the axis of the objective 570 is essentially proportional to the sine of this angle of incidence. The interference fringes 631 are in practice inclined at a given angle (45° in FIG. 13) equal to the average of the angles of incidence of the two separated light beams 621, 622. For maintaining a modulation along a given axis (for example according to X+Z in FIG. 13), the two separated light beams 621, 622 move in the rear focal plane Pf, moving away from and approaching the axis of the objective 570.

The device 100; 300 according to the invention can be implemented in many applications.

For example, the device 100; 300 according to the invention can be used to perform lifetime imaging of fluorescent particles. In other words, the device 100; 300 makes it possible to localize more precisely than the diffraction limit (thanks to the variation of the illumination field detailed above) of the particle(s) while measuring a relaxation time of the fluorescence of the particle 2. The relaxation time of the fluorescence of the particle 2, i.e. the time during which the particle emits fluorescence after illumination by the illumination field, provides information about its local chemical or biochemical intoxication.

For this purpose, the light emitter 130; 330 is particularly a laser pulsed at a frequency greater than 1 MHz. The detector 140; 340 is adapted to detect a single photon. The envelope of the signal is then representative of the scrolling of the interference fringes, which allows localization, and the individual detections of photons which form the signal can make it possible to measure a delay between a laser pulse and the emission of a photon by the particle in response to this pulse, as well as the duration of emission of photons by the particle which makes it possible to determine the lifetime of the fluorescence of the particle, that means the duration of the emission of photons by the particle 2, or in other words a relaxation time of the particle 2.

As another example, the device 100; 300 makes it possible to follow the movement of the particle 2, typically when the sample 3 is a biological fabric, since the particle 2 is localized at a high rate which is for example greater than 20 Hz.

The device 100; 300 according to the invention can be implemented in the context of multiplexing, i.e. a detection of photons at different wavelengths. Multiplexing here means that the sample 3 comprises at least two particles of different types: a first one emitting photons predominantly at a first wavelength and a second one emitting photons predominantly at a second wavelength distinct from the first wavelength. The emission spectra of the two particles can also be slightly offset while partially overlapping, the particles preferably remaining excitable with the same wavelength.

In a first type of multiplexing, the device 100; 300 comprises only one light source (the light source), which means here that the illumination field 200; 400 has a single main wavelength. The device 100 then comprises a second detector adapted to detect photons at the second wavelength. The detector 140; 340 is, as to itself, adapted to detect photons at the first wavelength.

In a second type of multiplexing, the device 100; 300 comprises two light sources, each adapted to produce an illumination field whose main frequency is adapted to one of the particles, and a single detector (i.e. detector 140), which is for example a spectrometer, adapted to detect photons at the first and second wavelengths.

The device 100; 300 according to the invention can also be used to produce a confocal or multi-confocal type system. The principle is then to replace the camera which is traditionally used in confocal or multi-confocal type systems, by the detector 140; 340 (which is of course coupled to the light source and to the computer 150; 350). Advantageously, the frequency localization by means of the illumination field of the sparse particles in the samples makes it possible to replace the camera with a single detector and, therefore, to increase the acquisition speed by at least one order of magnitude.

The present invention is in no way limited to the embodiments described and shown, but those skilled in the art will be able to provide any variation in accordance with the invention.

For example, the interference fringes can be circular fringes such as Newton's rings or even have other more complex profiles.

For example, the variation of the illumination field can be achieved by other means than by a scrolling of interference fringes. For example, the light source may comprise several lasers, each one illuminating a region of the sample in a time pattern specific to it. This time pattern corresponds, for example, to a laser pulsation frequency. So, by using lasers with pulsation frequencies distinct fom each other, it is possible to assign a specific frequency code to each region, which therefore makes it possible to localize the particle. As another example, the patterns can be produced by shaping the wave front (wave-front shaping) which makes it possible to obtain arbitrary shapes. They can also be produced by the superposition of non-coherent laser beams.

Thus, it also appears that the variation in intensity of the illumination field may vary in ways other than sinusoidal. For example, it may have a notched structure when pulsed lasers are used.

Consequently, it also appears that localization can be carried out in reference systems not comprising a main direction as described in the examples above. Indeed, when several lasers each illuminate a region of the sample according to its own temporal pattern, the regions can be distributed in two dimensions in the plane of the sample according to various patterns which do not necessarily imply that the regions are aligned or crisscross the sample. For example, the regions can correspond to concentric rings. The regions can also be arranged along a curved line.

The main direction, as well as the secondary direction and the third direction can, of course, correspond to a reference frame other than the orthogonal reference frame XYZ.

Other beam separating devices, other movable optical elements and other converging optical elements may be implemented.

In the second embodiment, the beams are selected on the basis of their polarization by optical means, in this case polarizing cubes. They can also be selected by mechanical means, such as galvanometric mirrors or rotating mirrors, or by acousto-optic means such as acousto-optic modulators.

Here, in order to localize one or more particles in a large sample, the sample 3 can be moved by means of the piezoelectric actuators 112. Different areas of the sample 3 are then treated one after the other as is the case in FIGS. 1 and 8. However, as a variant, the device can comprise several detectors. Each detector is then oriented towards a particular area of the support (and therefore of the sample) to convert photons emitted by the particle or particles of this particular area. In other words, the support and the sample are divided into areas, each area being associated with a detector. Within each area, several regions are then defined in order to carry out the localization described above.

Finally, the method of localizing shown in FIG. 12 can of course be implemented by any appropriate device and not exclusively by that represented in the figures.

1. Device for localization of an individualized particle in a sample having several regions, the particle being adapted to emit photons when it receives light, the device comprising:
a support for the sample,
a light source arranged to produce an illumination field adapted to illuminate the sample placed on its support, an intensity of the illumination field having a temporal and spatial variation, so that said intensity has, in each region of the sample, a predetermined temporal pattern different from the temporal patterns of the said intensity in the other regions;
a detector adapted to convert the photons emitted by the particle in response to its illumination by the illumination field in a signal representative of the intensity of the illumination field received by the particle;
a computer programmed to determine, on the basis of a temporal evolution of the signal from the detector and the temporal and spatial variation of the intensity of the illumination field, the region of the sample in which the particle is localized.

2. Device according to claim 1, wherein each temporal pattern of the intensity of the illumination field produced by the light source is a periodic temporal variation of this intensity and has a specific frequency, the specific frequencies of the temporal patterns associated with all the regions being distinct from each other.

3. Device according to claim 2, wherein the regions of the sample are aligned along a main direction (X) of the support and wherein the said light source is arranged so that each specific frequency is linked by the same relationship to a distance between the position of the region associated with the corresponding temporal pattern and a reference position along the main direction.

4. Device according to claim 3, wherein said relationship is a proportionality relationship.

5. Device according to claim 1, wherein the illumination field is adapted to illuminate simultaneously several regions of the sample.

6. Device according to claim 1, wherein each temporal pattern of the intensity of the illumination field produced by the light source is a sinusoidal temporal variation of its intensity.

7. Device according to claim 1, wherein the light source comprises an optical beam separating device and a converging element arranged to generate and make interfere two light beams with each other so as to produce interference fringes at the level of the sample placed on its support.

8. Device according to claim 7, wherein the optical light beam separating device comprises at least one of the following:
a corner mirror having two perpendicular reflecting surfaces, a mirror and a partially reflecting blade;
a separating cube having a partially reflecting internal diagonal surface.

9. Device according to claim 7, wherein the light source further comprises a movable optical element whose movement causes the scrolling of the said interference fringes to produce each temporal pattern of the intensity of the illumination field.

10. Device according to claim 9, wherein said movable optical element comprises a rotating device arranged to vary over time an angle of incidence of each light beam on the sample placed on its support the angles of incidence of the light beams varying simultaneously and in opposite directions.

11. Device according to claim 10, wherein the rotating device is a rotating mirror.

12. Device according to claim 1, wherein the light source comprises a polarization modulator adapted to modify the polarization of the illumination field so that the illumination field is polarized, sequentially or simultaneously, according to:
a first polarization direction; and
a second polarization direction distinct of the first polarization direction;
the computer being programmed to determine a position of the particle according to the first main direction and according to the second main direction as a function of the polarization of the illumination field.

13. Device according to claim 2, wherein, when the illumination field is simultaneously polarized according to the first and to the second direction, the specific frequencies of temporal patterns associated with the first polarization direction are distinct from the specific frequencies of temporal patterns associated with the second polarization direction.

14. Method of localizing an individualized particle in a sample having several regions, the particle being adapted to emit photons when it receives light, the method comprising the following steps:
arranging the sample on a support;
producing an illumination field, the illumination field illuminating the sample placed on the support, an intensity of the illumination field having a temporal and spatial variation, such that said intensity has, in each region of the sample, a predetermined temporal pattern different from the temporal patterns of said intensity in the others regions;
converting the photons emitted by the particle (2) in response to its illumination by the illumination field, into a signal representative of the intensity of the illumination field received by the particle;
determine, on the basis of a temporal evolution of the signal emitted by the detector and of the temporal and spatial variation of the intensity of the illumination field, the region of the sample in which the particle is localized.

15. A method according to claim 14, wherein the particle is selected from the group comprising: the diffusing particles, the fluorescent particles, the phosphorescent particles, the quantum dots, fluorescent proteins, dye molecules.

16. Method according to claim 14, according to which:
the particle is fluorescent,
the illumination field is produced by a laser pulsed at a frequency greater than 1 MHz, and
the detector is adapted to count the single photons,
the method comprising a step of determining a delay between a pulse of the laser and the emission of a photon by the particle.
